(19) United States
(12) Patent Application Publication
(10) Pub. No.: US 2015/0161599 A1
(43) Pub. Date: Jun. 11, 2015

(54) MANAGEMENT OF COMPLEX TRANSACTIONS

(71) Applicant: MASTERCARD INTERNATIONAL INCORPORATED, Purchase, NY (US)

(72) Inventors: Michael SASS, Brussels (BE); Arnaud le MASNE, Etterbeek (BE); Thierry HUBERT, Perwez (BE)

(21) Appl. No.: 14/560,465

(22) Filed: Dec. 4, 2014

(30) Foreign Application Priority Data
Dec. 6, 2013 (GB) 1321541.3

(51) Int. Cl. G06Q 20/38

(52) U.S. Cl. CPC G06Q 20/38

(57) ABSTRACT

A method of settling a transaction comprises the following elements. First of all, a class of transactions for a merchant that create an obligation to a third party is established. This class of transactions is notified to a settlement system. When the merchant conducts a transaction from the class the settlement system is notified, directly or indirectly, with a suitable message. The settlement system settles the transaction, when authorised, as a split settlement directly with the merchant or its acquiring bank and directly with the third party or its acquiring bank. Suitable apparatus and systems for implementation of such methods are described.

### FIELD OF DISCLOSURE

This disclosure relates generally to methods, apparatus and systems for use in the management of complex transactions. While applicable to other contexts, embodiments of the disclosure are particularly, but not exclusively, relevant to the management of payments where commission is owed on a payment made.

### BACKGROUND OF DISCLOSURE

Payment cards such as credit cards and debit cards are very widely used for all forms of financial transaction. The use of payment cards has evolved significantly with technological developments over recent years. Many payments are made at a retail location, typically with a physical transaction card interacting with a point of sale (POS) terminal to perform a transaction. These transaction cards may interact with a POS by swiping through a magnetic stripe reader, or for a “chip card” or “smart card” by direct contact with a smart card reader (under standard ISO/IEC 7816) or by contactless interaction through local short range wireless communication (under standard ISO/IEC 14443).

Cards of this type typically operate under the EMV standard for interoperation of chip cards and associated apparatus (such as POS terminals and ATMs). ISO/IEC 7816 provides a standard for operation of cards of this type. EMVCo provides standards for operation of cards of this type.

In addition to these card usage models, there are also an increasing number of CNP (Customer Not Present) transactions. These typically take place telephonically or online, and transactions are authorised by provision of the card's PAN (Primary Account Number) together with such a selection of further credentials (such as cardholder name, card expiry date and CVV code) considered sufficient for the card issuer to authorise the transaction.

CNP transactions are particularly common in commerce over the public internet. These transactions may be complex, as it is common for a customer to make a transaction choice through a website controlled by a first party (for example, a site which aggregates different vendors for a particular product) with the transaction actually carried out with a second party (for example, the vendor for the selected product). In these cases, there will normally be an agreement between the first and second parties to share revenue received from the transaction—typically, this will be a commission received by the first party corresponding to a fraction of the sale price.

In a typical architecture for a transaction card payment system, such a transaction is made between the cardholder and the merchant, but with the merchant owing a percentage of the sale price to the aggregator, or other intermediary (this general term will be used from now on to describe parties entitled to derive a benefit from a transaction to which they are not a direct party). The transaction is carried out between the issuing (cardholder) bank and the acquiring bank. The intermediary and the intermediary bank are not parties to this transaction. The merchant is however required to advise the intermediary of the transaction, at which point the intermediary will invoice the merchant. The settlement of the invoice is a separate transaction entirely.

This model is not efficient and does not offer security for all the parties. Although all aspects of the transaction can be determined at the time the transaction is made, the “full” transaction is carried out as two transactions, separated in time. This also means that the intermediary—who does not receive any initial payment, but must instead seek to recover from the merchant—is at a significant disadvantage as the merchant will recover last and is reliant on the merchant having notified the transaction to the intermediary. It would be desirable to develop a more effective transaction model.

### SUMMARY OF DISCLOSURE

Broadly conceived, the disclosure provides a method of settling a transaction, comprising: identifying a class of transactions for a merchant that create an obligation to a third party, and notifying the class of transactions to a settlement system; the merchant conducting a transaction from the class and notifying the settlement system, directly or indirectly; and the settlement system settling the transaction, when authorised, as a split settlement directly with the merchant or an acquiring bank for the merchant and also directly with the third party or an acquiring bank for the third party.

In a first aspect, the disclosure provides a method of using a settlement system to settle a transaction for payment to multiple parties, comprising: defining a tag to be used by the settlement system to refer a transaction for payment to multiple parties to a split settlement system, defining a split settlement rule associated with the tag, and communicating the tag to one or more merchants; receiving a message from an acquirer of one merchant of the one or more merchants defining a transaction for settlement and including the tag; and referring the transaction and the tag to a split settlement system comprising a programmed processor and a memory, wherein the split settlement system uses the tag to recover the associated split settlement rule from the memory, and the programmed processor applies the split settlement rule to the transaction to determine settlement to the multiple parties.

Using this approach, a single transaction can be used to provide benefit to a third party entitled to receive that benefit by use of a split settlement. This reduces the load on a banking and payment infrastructure by reducing an overall number of transactions, and it simplifies process and accounting for both merchants and third party intermediaries such as aggregator and price comparison websites without any impact on the customer.

Defining a tag may further comprise receiving a split settlement rule from one of the one or more merchants and storing the rule in the split settlement database indexed with the tag. Defining a tag may further comprise either receiving authorization from, or providing notification to, each of the multiple parties to the transaction.

Referring the transaction and the tag to a split settlement system may take place when funds are received from a purchaser to initiate settlement. This fits split settlement effectively into existing settlement processes.

In one use case, one of the multiple parties is the one merchant and another party obtains commission from the transaction. In another use case, one of the multiple parties is the one merchant and another party is a provider of a token used for part-payment of the transaction.

In a second aspect, the disclosure provides a method for a merchant to arrange for settlement of a transaction for payment to multiple parties, the merchant having a merchant system comprising a programmed processor and a memory, the method comprising the merchant system: notifying a transaction type for payment to multiple parties to a split settlement system, establishing a split settlement rule for allocating payment to the multiple parties with the split settlement system, receiving a tag for the transaction type from the split settlement system, and storing the tag in the memory; and on conducting a transaction as defined by the transaction type, providing the transaction for clearance to an acquirer with the tag for the transaction type.

Establishing a split settlement rule may comprise ensuring that the split settlement system either receives authorization from, or provides notification to, each of the multiple parties to the transaction.

In one use case, one of the multiple parties is the one merchant and another party obtains commission from the transaction. The one merchant may for example provide an online store, and the another party may provide online referral to the online store of the one merchant.

In another use case, one of the multiple parties is the one merchant and another party is a provider of a token used for part-payment of the transaction. Here, the another party may be a voucher provider, with the transaction part paid by voucher.

In a third aspect, the disclosure provides a split settlement system comprising a programmed processor and a memory, wherein the programmed processor of the split settlement system is adapted to: define a tag to be used by the settlement system to refer a transaction for payment to multiple parties to a split settlement system, define a split settlement rule associated with the tag, store the split settlement rule and the tag in the memory, and to communicate the tag to one or more merchants; receive a message from an acquirer of one merchant of the one or more merchants defining a transaction for settlement and including the tag; and on receiving notification of the transaction and the tag, use the tag to recover the associated split settlement rule from the memory, and apply the split settlement rule to the transaction to determine settlement to the multiple parties.

Defining a tag may further comprise receiving a split settlement rule from one of the one or more merchants and storing the rule in the split settlement database indexed with the tag. Defining a tag may further comprise either receiving authorization from, or providing notification to, each of the multiple parties to the transaction.

The split settlement system may be adapted for receiving notification of the transaction and the tag when funds are received from a purchaser to initiate settlement.

### BRIEF DESCRIPTION OF FIGURES

Embodiments of the disclosure will now be described, by way of example, with reference to the accompanying Figures, of which:

FIG. 1 shows elements of a system suitable for carrying out embodiments of the disclosure;

FIGS. 2a and 2b illustrate a practical situation for which embodiments of the disclosure may be used;

FIG. 3 shows a process flow for an aspect of the disclosure;

FIG. 4 shows a process flow in establishment of split settlement for a class of transactions;

FIG. 5 shows a process flow in a transaction for which split settlement has been established; and

FIG. 6 shows a process flow in settlement of a transaction to which split settlement applies.

### DESCRIPTION OF SPECIFIC EMBODIMENTS

Specific embodiments of the disclosure will be described below with reference to the Figures.

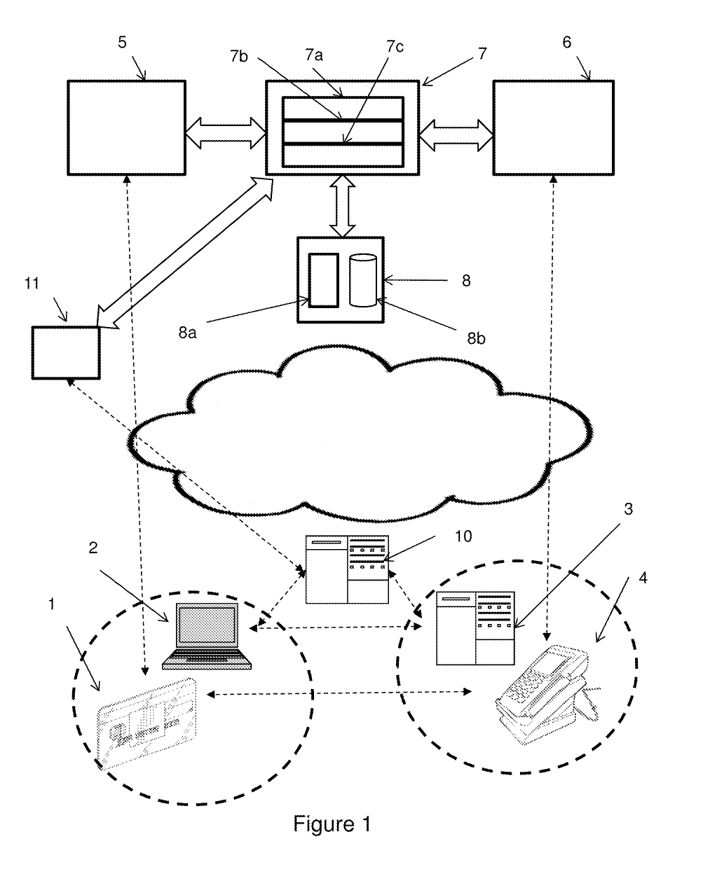

FIG. 1 shows schematically relevant parts of a representative transaction system suitable for implementing an embodiment of the disclosure.

A user (not shown) is provided with a payment device—this may be for example a payment card 1, but in particular embodiments it may be a computing device used as a proxy for a payment card (such as a mobile phone or a laptop computer 2)—or provides sufficient information in the form of credentials associated with a physical payment card to a merchant to initiate a Customer Not Present (CNP) transaction, for example by telephone or over the public internet. Payment cards and payment card proxies will typically be equipped with means to communicate with other elements of a payment infrastructure. These communication means may comprise contacts on a payment card 1 to allow communication by protocols such as those defined under ISO/IEC 7816, they may comprise antennae and associated hardware and software to enable communication by NFC and associated contactless card protocols such as those defined under ISO/IEC 14443, or they may comprise an antenna and associated hardware and software to allow local wireless networking using 802.11 rotocols or any combination of the above.

Other computer equipment in the infrastructure is typically fixed, such as point of interaction (POI) terminals 4, of which the example shown is a point-of-sale (POS) terminal used by a merchant interacting with the user. In the case of a CNP transaction, the merchant will typically be represented by a merchant server 3—payment may not be provided by a server controlled by the merchant, but may be outsourced to a payment service provider (PSP). Of particular interest here are transactions which take place by referral—for example, by use of a referring website on third party server 10 which refers the cardholder to merchant server 3. The merchant server 3 is typically connected or connectable to an acquiring bank 6 or other system in a secure way (either through a dedicated channel or through a secure communication mechanism over a public or insecure channel). The third party server 10 represents an intermediary, and is associated with an intermediary acquiring bank 11. There may also be a mechanism to allow connection between the user computer devices and a card issuing bank 5 or system associated with the user. A banking and payment infrastructure 7 will also connect the card issuer 5 and the acquiring bank 6, allowing transactions to be carried out between them. This banking and payment infrastructure will typically be provided by a transaction card provider who provides transaction card services to the card issuing bank 5. The banking and payment infrastructure 7 provides authorization at the time of purchase, clearing of the transaction and reconciliation typically within the same working day, and settlement of payments shortly after that—these aspects are shown in modular form as authorization system 7a, reconciliation system 7b and settlement system 7c. The banking and payment infrastructure 7 comprises a plurality of switches, servers and databases, and is not described further here as the details of the banking and payment infrastructure used are not necessary for understanding how embodiments of the disclosure function and may be implemented.

The elements already described are conventional. An additional element associated with embodiments of the disclosure is split settlement system 8, which is shown here as a separate element comprising a server 8a and a database 8b. This may be provided as an integral part of the banking and payment infrastructure 7—specifically as a part of its settlement system—or may be provided by a third party interacting with the banking and payment infrastructure in an appropriately trusted relationship.

The split settlement system 8 is used in embodiments of the disclosure to assist in management of settlement where there are payment obligations to a party other than the cardholder and the merchant in the course of a transaction. This is achieved by the merchant or the acquirer tagging a transaction in such a way that when it arrives at the settlement system 7c of the banking and payment infrastructure 7 it will refer the transaction to the split settlement system 8 in the settlement process. This allows the settlement system 7c to manage settlement directly with not only the direct parties to the transaction (the cardholder and the merchant, as represented by their banks) but also with one or more indirect parties to whom one of the direct parties has a payment obligation arising from the transaction. This process is operated by the split settlement system server 8a by use of split settlement system database 8b, which comprises settlement rules associated with each split settlement tag. This process is discussed in more detail below.

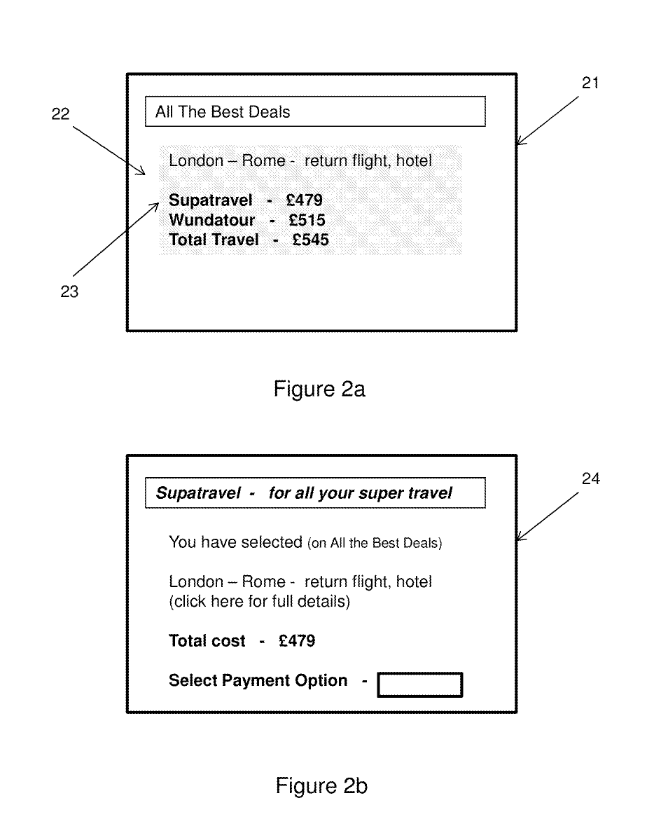

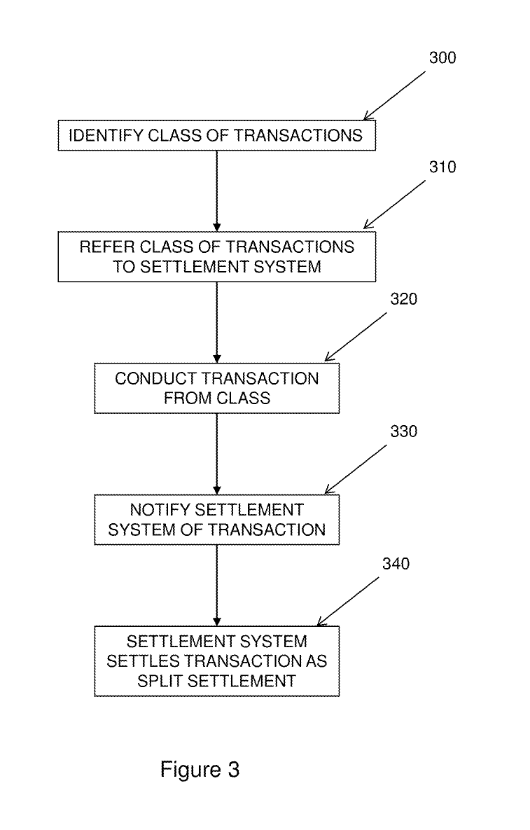

A typical situation in which obligations to third parties arise is in Internet transactions conducted through an intermediary merchant, such as a price comparison website or an offer collating website. When a customer shops online for a particular product, the customer will often use intermediaries of this type either to obtain better prices or because the customer trusts a well-known intermediary more than a previously unknown merchant. As shown in FIG. 2a, the customer will typically be provided at the intermediary website 21 with a list 22 of alternative merchants and prices for the product. On clicking a preferred choice 23 in the list, the merchant website 24 is called, as shown in FIG. 2b, and the customer completes the transaction. The transaction may or may not indicate involvement of the intermediary website, but it will typically result in an obligation on the merchant to pay a percentage of the sale price to the intermediary as commission. As noted above, this is conventionally managed by the merchant notifying the intermediary that a referred transaction has taken place, and by the intermediary billing the merchant for the commission as a separate transaction. In one aspect, the disclosure provides the following approach, illustrated in FIG. 3. First of all, a class of transactions are identified 300 for a merchant that create an obligation to a third party—these may be, for example, referrals from a price comparison or aggregation website as discussed above. This class of transactions is then referred 310 to a settlement system.

When the merchant conducts a transaction from this class (step 320), the settlement system is notified 330, directly or indirectly. When authorization has been received to do so, the settlement system then settles 340 the transaction as a split settlement directly with the merchant or an acquiring bank therefor and directly with the third party or an acquiring bank therefor.

This approach enables a single transaction to be carried out which uses the settlement process to address all obligations related to the transaction. While the examples shown here involve the merchant making a commission payment to a referrer, the approach shown here can in principle be used for more complex transactions, in which there are a greater number of parties receiving a benefit from the transaction and in which the settlement rules are more complex than a percentage commission.

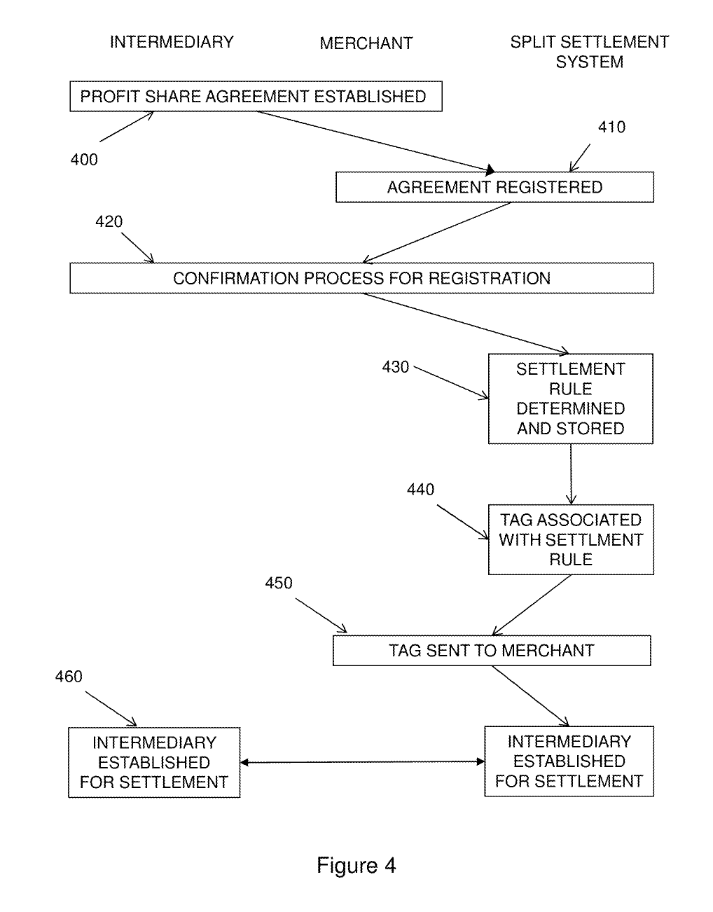

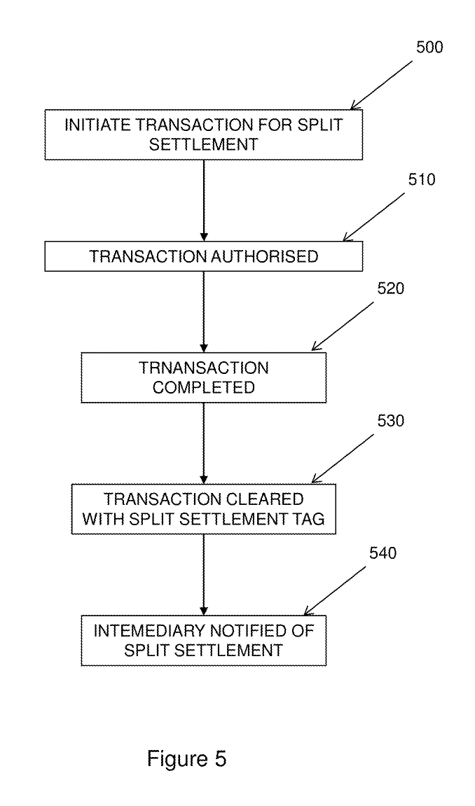

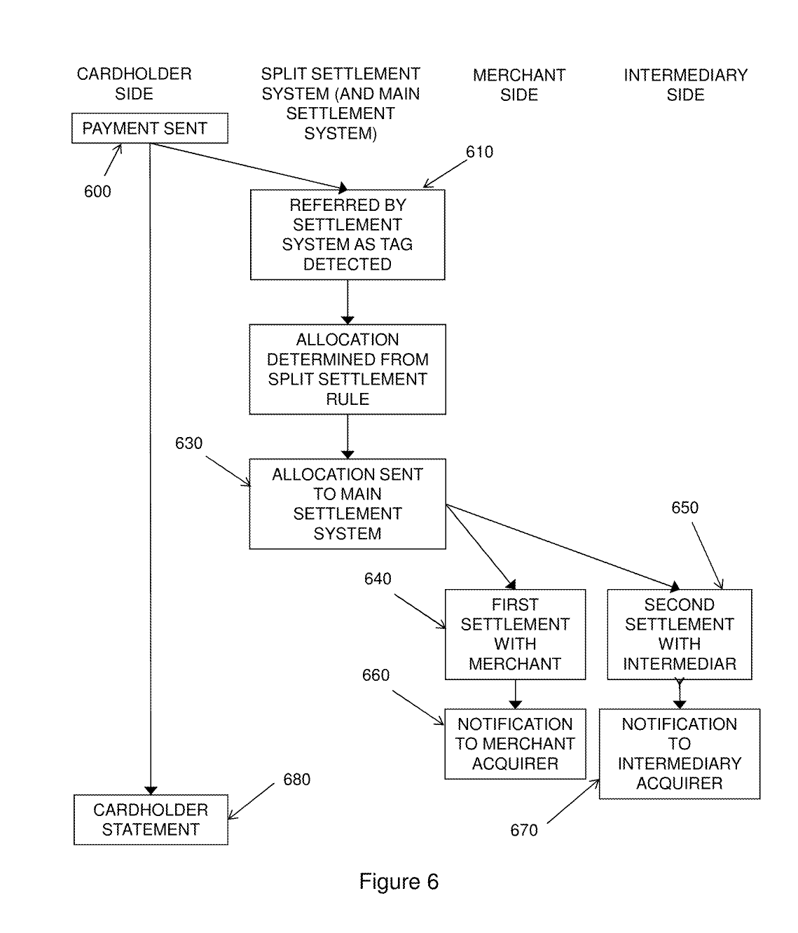

A system and process for carrying out split settlement according to an embodiment of the disclosure will now be described with reference to FIGS. 4 to 6. FIG. 4 shows a process flow in establishment of split settlement for a class of transactions. FIG. 5 shows a process flow in a transaction for which split settlement has been established. FIG. 6 shows a process flow in settlement of a transaction to which split settlement applies.

FIG. 4 shows a process flow involving the intermediary, the merchant and the split settlement system to establishment a split settlement process for transactions referred to the merchant by the intermediary. First of all it is established 400 between the intermediary and the merchant that there will be revenue or profit sharing from a transaction—for example, a contractual agreement that 2% of the value of a transaction referred by the intermediary to the merchant will be paid to the intermediary. This contractual agreement is then registered 410 with the split settlement system —this registration process will require an appropriate confirmation (and possibly authentication) process 420 to assure the split settlement system that the intermediary and the merchant have both authorised this revenue division (in some use cases, this authorization may only need to come from the merchant, as the merchant will otherwise receive the full benefit of the transaction—the intermediary will however require at least some confirmation that the transaction type has been registered with the split settlement system). When the confirmation process 420 is complete, a settlement rule for the transaction will be stored 430 in the split settlement system. This settlement rule needs to be sufficient to allow received funds to be allocated between the intermediary and the merchant for any transaction. The settlement rule will include destinations for all funds received in a transaction—for example, acquiring banks for the merchant and the intermediary. A tag is associated 440 with the settlement rule, the purpose of the tag being to allow the settlement rule to be accessed for a transaction. The tag is then communicated 450 to the merchant, and also to the banking and payment infrastructure, as both these parties will need to use the tag in a split settlement transaction. In addition, the intermediary will need to be established 460 by the banking and payment infrastructure as a potential participant in settlement, either directly or through an acquiring bank.

The process flow in a transaction to which split settlement applies is set out in FIG. 5. First of all, a transaction to which split settlement applies is initiated 500—for example, a transaction following a referral of the type shown in FIGS. 2a and 2b. This transaction is authorized 510 in the conventional way, as the split settlement process has no effect on authorization, and the transaction then completes 520, with appropriate confirmation to the merchant and to the customer. However, when the transaction is referred by the merchant to the acquiring bank on clearance 530, it includes a split settlement flag and the tag communicated to the merchant from the split settlement system. When the banking and payment infrastructure is notified of the transaction, it will therefore be aware from the split settlement flag and the tag that split settlement applies, and will be aware that at the settlement phase a reference to the split settlement system will be required. It is desirable also for notification to be made 540 to the intermediary at this time—this may be a further obligation established contractually between the intermediary and the merchant—to allow the transaction to be identified effectively by the intermediary and so to allow the intermediary to be able to audit the process of payment effectively, and to determine other issues of relevance to the intermediary (such as the success rate of click-through referrals).

Unlike the authorization and clearance processes, the settlement process is significantly modified, as is shown in FIG. 6. When payment is sent 600 from the cardholder bank, the banking and payment infrastructure determines from the split settlement flag and the tag associated with the transaction that it needs to refer 610 to the split settlement system. The split settlement system uses the tag to recover the split settlement rule associated with the tag. The split settlement system then uses the transaction details and the split settlement rule to allocate 620 the funds received from the cardholder bank to the parties concerned—in this case, to the merchant's acquiring bank and the intermediary's acquiring bank. In this case, the rule will be straightforward (after any deduction such as fees for use of the banking and payment infrastructure, 98% of the funds are to be credited to the merchant at the merchant's acquiring bank and 2% of the funds are to be credited to the intermediary at the intermediary's acquiring bank), but in principle a rule may be more complex and be affected by other elements of the transaction. The allocation details are sent 630 to the settlement system of the banking and payment infrastructure, which then makes a first settlement 640 with the merchant's acquiring bank and a second settlement 650 with the intermediary's acquiring bank in accordance with the allocation details. The merchant's acquirer will receive 660 a standard settlement notification, augmented with a confirmation that the settlement was split. The intermediary's acquirer will receive 670 a settlement notification including transaction details. The cardholder, however, need only receive 680 in any statement a debit of the amount of the transaction with the merchant's details—as the transaction between the intermediary and the merchant may be private between these two parties, it need not be provided to the cardholder.

While this has been discussed above in the context of payment of commission to a referrer, the same approach may be used in many different contexts. As discussed above, more than two parties could receive some benefit from a transaction and could be identified as recipients for funds in a settlement rule held in the split settlement system. Split settlement could arise in contexts other than referral. For example, a merchant may designate that a charitable donation may be given for each transaction of a certain type, and this type of transaction may be included in the split settlement database, with the charity identified as a split settlement recipient. A transaction tax could also be managed by designating a government collection agency as a split settlement recipient, so that the tax associated with a transaction is sent directly to the collection agency in the settlement process and not billed separately.

As the person skilled in the art will appreciate, modifications and variations to the above embodiments may be provided, and further embodiments may be developed, without departing from the spirit and scope of the disclosure.

The use case discussed above is that of online transactions with associated commission. Third party commitments can arise in other situations. Some of these situations arise when a customer is physically present and the customer's card is interacting directly with a POS terminal. One such situation is the use of a meal voucher, or of a gift card, in partial payment for a transaction. When the voucher is scanned in, rather than initiating a separate transaction with the meal voucher or gift card provider (hereafter “voucher provider”), the main transaction may instead be tagged to indicate that split settlement should be used, with the amount of the meal voucher or gift card (less any charges) to be settled with the voucher provider. In this case the tag may need to include a monetary amount associated with the meal voucher, or may possibly include a reference by which the split settlement system may access a voucher provider database to determine the amount that should be settled with the voucher provider or its acquiring bank.

Reference to standards and proprietary technologies are provided for the purpose of describing effective implementations, and do not limit the scope of the disclosure.

1. A method of using a settlement system to settle a transaction for payment to multiple parties, comprising:
defining a tag to be used by the settlement system to refer a transaction for payment to multiple parties to a split settlement system, defining a split settlement rule associated with the tag, and communicating the tag to one or more merchants;
receiving a message from an acquirer of one merchant of the one or more merchants defining a transaction for settlement and including the tag;
referring the transaction and the tag to a split settlement system comprising a programmed processor and a memory, wherein the split settlement system uses the tag to recover the associated split settlement rule from the memory, and the programmed processor applies the split settlement rule to the transaction to determine settlement to the multiple parties.

2. The method as claimed in claim 1, wherein defining a tag further comprises receiving a split settlement rule from one of the one or more merchants and storing the rule in the split settlement database indexed with the tag.

3. The method as claimed in claim 1, wherein defining a tag further comprises either receiving authorization from, or providing notification to, each of the multiple parties to the transaction.

4. The method as claimed in claim 1, wherein referring the transaction and the tag to a split settlement system takes place when funds are received from a purchaser to initiate settlement.

5. The method as claimed in claim 1, wherein one of the multiple parties is the one merchant and another party obtains commission from the transaction.

6. The method as claimed in claim 1, wherein one of the multiple parties is the one merchant and another party is a provider of a token used for part-payment of the transaction.

7. A method for a merchant to arrange for settlement of a transaction for payment to multiple parties, the merchant having a merchant system comprising a programmed processor and a memory, the method comprising the merchant system:
notifying a transaction type for payment to multiple parties to a split settlement system, establishing a split settlement rule for allocating payment to the multiple parties with the split settlement system, receiving a tag for the transaction type from the split settlement system, and storing the tag in the memory; and
on conducting a transaction as defined by the transaction type, providing the transaction for clearance to an acquirer with the tag for the transaction type.

8. The method as claimed in claim 7, wherein establishing a split settlement rule comprises ensuring that the split settlement system either receives authorization from, or provides notification to, each of the multiple parties to the transaction.

9. The method as claimed in claim 7, wherein one of the multiple parties is the one merchant and another party obtains commission from the transaction.

10. The method as claimed in claim 9, wherein the one merchant provides an online store, and wherein the another party provides online referral to the online store of the one merchant.

11. The method as claimed in claim 7, wherein one of the multiple parties is the one merchant and another party is a provider of a token used for part-payment of the transaction.

12. The method as claimed in claim 11, wherein the another party is a voucher provider, and wherein the transaction is part paid by voucher.

13. A split settlement system comprising a programmed processor and a memory, wherein the programmed processor of the split settlement system is adapted to:
define a tag to be used by the settlement system to refer a transaction for payment to multiple parties to a split settlement system, define a split settlement rule associated with the tag, store the split settlement rule and the tag in the memory, and to communicate the tag to one or more merchants;
receive a message from an acquirer of one merchant of the one or more merchants defining a transaction for settlement and including the tag; and
on receiving notification of the transaction and the tag, use the tag to recover the associated split settlement rule from the memory, and apply the split settlement rule to the transaction to determine settlement to the multiple parties.

14. The split settlement system as claimed in claim 13, wherein defining a tag further comprises receiving a split settlement rule from one of the one or more merchants and storing the rule in the split settlement database indexed with the tag.

15. The split settlement system as claimed in claim 13, wherein defining a tag further comprises either receiving authorization from, or providing notification to, each of the multiple parties to the transaction.

16. The split settlement system as claimed in claim 13, wherein the split settlement system is adapted for receiving notification of the transaction and the tag when funds are received from a purchaser to initiate settlement.
